(19) United States
(12) Patent Application Publication
(10) Pub. No.: US 2026/0356454 A1
(43) Pub. Date: Nov. 12, 2026

(54) OPERATION APPARATUS AND STEERING APPARATUS

(71) Applicant: ALPS ALPINE CO., LTD., Tokyo (JP)

(72) Inventors: Yuki IKEZOE, Miyagi (JP); Masaaki MIKAWA, Miyagi (JP)

(21) Appl. No.: 19/718,151

(22) Filed: Jun. 24, 2026

Related U.S. Application Data
(63) Continuation of application No. PCT/JP2024/041361, filed on Nov. 21, 2024.

(30) Foreign Application Priority Data
Jan. 15, 2024 (JP) 2024-003973

(51) Int. Cl. B62K 21/26; B62J 50/21

(52) U.S. Cl. CPC B62K 21/26; B62J 50/21

(57) ABSTRACT

An operation apparatus includes: a body having a rod shape fixed to an apparatus to be operated; a holder provided at an end of the body; a grip held by the holder and grasped by an operator's hand; and a vibration generating apparatus provided inside the grip. One of the holder or the grip includes a recess, another of the holder or the grip includes an insertion portion to be inserted into the recess, and a first elastic member is provided between an inner peripheral surface of the recess and an outer peripheral surface of the insertion portion.

### CROSS-REFERENCE TO RELATED APPLICATIONS

This application is a continuation application of International Application No. PCT/JP2024/041361, filed on Nov. 21, 2024, and designated the U.S., which is based upon and claims priority to Japanese Patent Application No. 2024-003973, filed on Jan. 15, 2024, the entire contents of which are incorporated herein by reference.

### TECHNICAL FIELD

The present disclosure relates to an operation apparatus and a steering apparatus.

### BACKGROUND ART

Patent Document 1 below discloses a technique in which a switch casing for housing a vibrating means is mounted on a handlebar of a vehicle to vibrate a gripping grip through the handlebar.

### RELATED ART DOCUMENTS

### Patent Documents

Patent Document 1: Japanese Laid-Open Patent Application No. 2021-165067

### SUMMARY OF THE INVENTION

An operation apparatus according to an embodiment is provided with a body having a rod shape fixed to an apparatus to be operated, a holder provided at an end of the body, a grip held by the holder and grasped by an operator's hand, and a vibration generating apparatus provided inside the grip, wherein one of the holder or the grip includes a recess, the other of the holder or the grip includes an insertion portion to be inserted into the recess, and a first elastic member is provided between an inner peripheral surface of the recess and an outer peripheral surface of the insertion portion.

### BRIEF DESCRIPTION OF THE DRAWINGS

FIG. 1 is a diagram illustrating an external perspective view of a steering assembly according to one embodiment;

FIG. 2 is an exploded view of a holder and a grip according to the embodiment;

FIG. 3 is a cross-sectional view of the holder and the grip according to the embodiment; and

FIG. 4 is a diagram illustrating an installation example of the steering assembly according to the embodiment.

### DETAILED DESCRIPTION OF THE INVENTION

However, since the technique disclosed in Patent Document 1 has a structure for vibrating the whole of the handlebar, it is not possible to selectively vibrate the grip of the handlebar greatly.

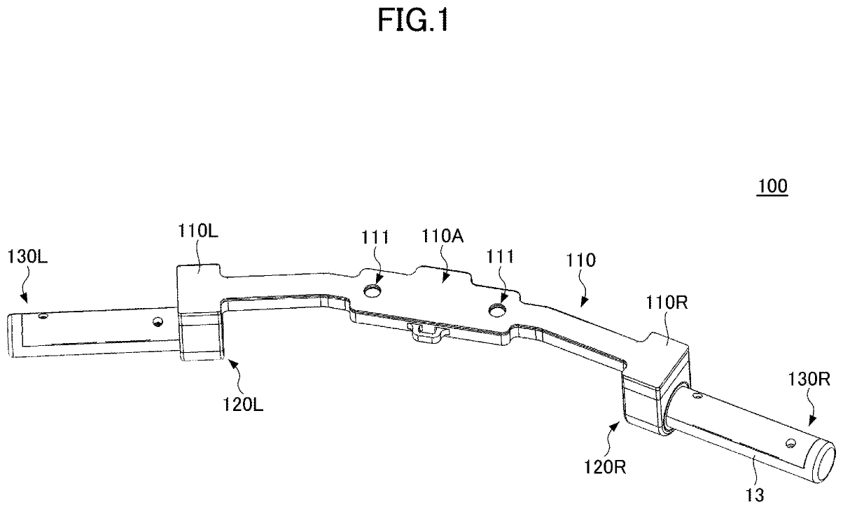

Hereinafter, one embodiment will be described with reference to the drawings. In the following description, the right side in FIG. 1 is defined as the right side, and the left side in FIG. 1 is defined as the left side.

### Configuration of Steering Assembly 100

FIG. 1 is an external perspective view of a steering assembly 100 according to one embodiment. The steering assembly 100 illustrated in FIG. 1 is an example of an “operation apparatus”. As illustrated in FIG. 1, the steering assembly 100 includes a body 110, a pair of left and right holders 120 (holders 120L and 120R), and a pair of left and right grips 130 (grips 130L and 130R).

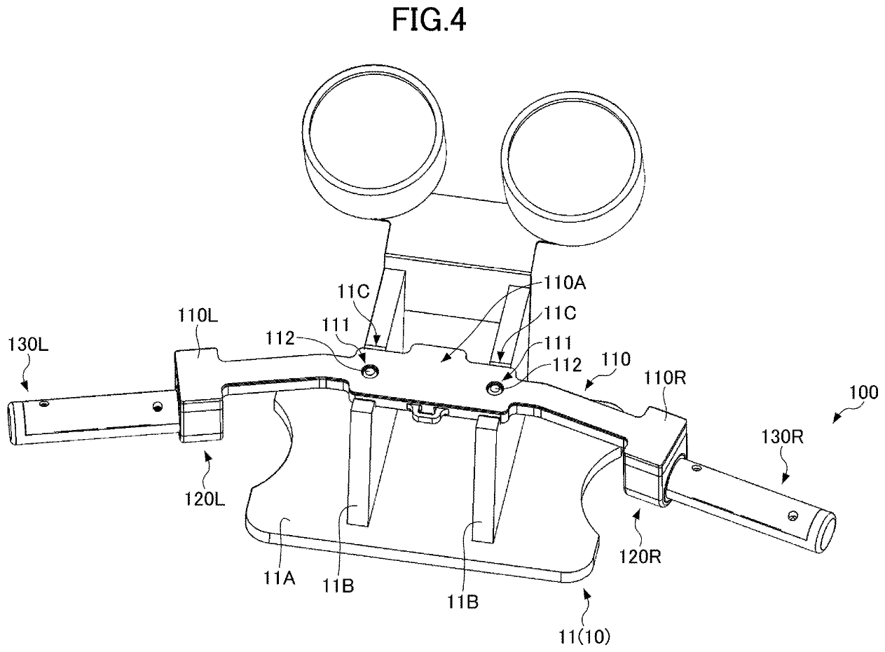

The body 110 is a rod-shaped member having a rectangular cross section and extending in left and right directions. The body 110 may have a shape other than a rectangular cross section (for example, a round shape, etc.) as long as it is rod-shaped. The body 110 is fixed to the apparatus to be operated by an optional fixer. As an example, the body 110 includes a pair of right and left through holes 111 in a central portion 110A, and is fixed to the apparatus to be operated by a pair of fixing screws 112 (see FIG. 4) penetrating through the pair of right and left through holes 111. The body 110 is formed of a relatively hard material (e.g., metals, hard resins, etc.).

The holder 120L is provided at a left-end portion 110L of the body 110. The holder 120L holds the grip 130L. The holder 120R is provided at a right-end portion 110R of the body 110. The holder 120R holds the grip 130R. The holders 120L and 120R are formed by using a relatively hard material (e.g., metals, hard resins, etc.).

The grip 130L is a cylindrical rod-shaped member held by the holder 120L and extending leftward from the holder 120L. The grip 130L is held by the operator's left hand. The grip 130R is a cylindrical rod-shaped member held by the holder 120R and extending rightward from the holder 120R. The grip 130R is held by the operator's right hand. The grips 130L and 130R are formed of a relatively hard material (e.g., metals, hard resins, etc.).

### Structure for Holding Grip 130R by Holder 120R

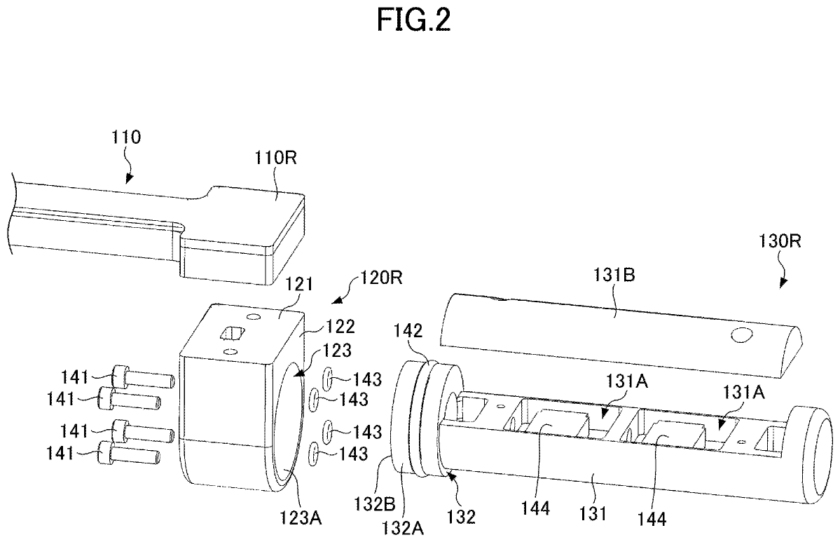

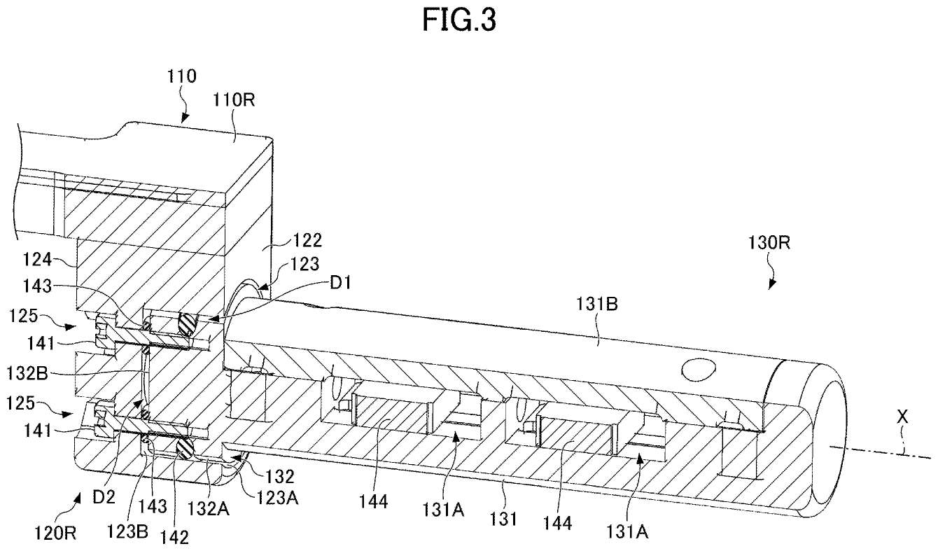

FIG. 2 is an exploded view of the holder 120R and the grip 130R according to one embodiment. FIG. 3 is a cross-sectional view of the holder 120R and the grip 130R according to the embodiment.

The holder 120R has a horizontal planar upper surface 121. The holder 120R is fixed by screwing to the bottom surface (the surface facing the upper surface 121) of the right-end portion 110R of the body 110 on the upper surface 121.

The holder 120R has a recess 123 which is recessed from a right side surface 122 of the holder 120R toward the left (the same direction as an axial direction of a central axis X of the grip 130R) coaxially with the central axis X of the rod-shaped grip 130R. The recess 123 has a cylindrical spatial shape, and an insertion portion 132 of the grip 130R can be inserted into the cylindrical space.

The holder 120R includes four through holes 125 penetrating from a left side surface 124 to an inner bottom surface 123B of the recess 123.

The grip 130R generally has a cylindrical rod-shaped appearance extending linearly in a left-right direction. The grip 130R includes a grip portion 131 and the insertion portion 132. The grip portion 131 is formed in a cylindrical rod shape and is a portion to be grasped by the right hand of the operator. The grip portion 131 may have a cross section other than a round shape (for example, rectangular shape, etc.). The insertion portion 132 is provided at the left end of the grip portion 131 and is a cylindrical portion to be inserted into the recess 123 of the holder 120R.

As illustrated in FIG. 3, the grip 130R is held by the holder 120R when the insertion portion 132 is inserted into the recess 123 of the holder 120R.

With the insertion portion 132 inserted into the recess 123 of the holder 120R, the grip 130R is screwed and fixed to the holder 120R by four fixing screws 141 (an example of a “fixing member”). Each of the four fixing screws 141 passes through a corresponding through hole 125 of the four through holes 125 of the holder 120R, the inner bottom surface 123B of the recess 123, a second space D2 described in the following, and an end surface 132B of the insertion portion 132 of the grip 130R to be screwed into the insertion portion 132.

As illustrated in FIGS. 3 and 4, two accommodating spaces 131A are formed inside the grip portion 131 of the grip 130R to be spaced apart from each other in the left-right direction. Two vibration generating apparatuses 144 are disposed in the two accommodating spaces 131A, respectively.

Thus, in the steering assembly 100 according to the embodiment, when a predetermined vibration generating condition is satisfied, each of the two vibration generating apparatuses 144 is controlled by a control apparatus (not illustrated) to generate vibration, thereby vibrating the grip 130R and transmitting the vibration to the operator's right hand.

In particular, in the steering assembly 100 according to an embodiment, since the distal end side (left end side) of the grip 130R is held by the holder 120R, a vibration displacement amount of the distal end side (right end side) of the grip 130R can be increased, and the grip 130R can be vibrated to incline. Therefore, the grip portion 131 held by the operator's right hand can be vibrated greatly.

In addition, in the steering assembly 100 according to the embodiment, from the viewpoint that the grip 130R can be vibrated greatly, the ratio of the length in the central axis X direction of the insertion portion 132 inserted into the recess 123 of the holder 120R of the grip 130R to the length in the axial direction of the central axis X of the grip portion 131 which is not inserted into the recess 123 and can be held by the operator is set to 1:8, but any ratio within the range from 1:6 to 1:10 can be used.

The upper portion of the grip portion 131 of the grip 130R is a detachable cover 131B. Thus, the steering assembly 100 according to the first embodiment can arrange the two vibration generating apparatuses 144 inside the grip portion 131 by removing the cover 131B.

Furthermore, in the present embodiment, as an example, the vibration direction of the two vibration generating apparatuses 144 is a radial direction of the round bar which is the direction orthogonal to the central axis X of the rod-shaped grip 130R, but this is not limited to this, and the vibration direction of at least one of the two vibration generating apparatuses 144 may be the same direction as the central axis X.

Here, as illustrated in FIG. 3, the diameter of the recess 123 of the holder 120R is slightly larger than the diameter of the insertion portion 132 of the grip 130R. Thus, a first space D1 is formed between an inner peripheral surface 123A of the recess 123 of the holder 120R and an outer peripheral surface 132A of the insertion portion 132 of the grip 130R. Therefore, the grip 130R can be vibrated larger in the radial direction within the recess 123 by the amount of the first space D1.

Thus, the steering assembly 100 according to one embodiment can selectively vibrate the grip 130R to a greater extent, thereby increasing the vibration transmitted to the operator's right hand.

In the first space D1, an O-ring 142 having an annular shape (an example of a shape extending along the circumferential direction of the outer peripheral surface of the insertion portion), which is attached to the outer peripheral surface 132A of the insertion portion 132 of the grip 130R, is disposed. The O-ring 142 is an example of a “first elastic member” and is formed by using an elastic material (for example, rubber, silicon, etc.). Although the O-ring 142 is used as the “first elastic member” in the present embodiment, a plurality of elastic bodies may be disposed to be scattered along the outer peripheral surface 132A.

The steering assembly 100 according to the embodiment includes the O-ring 142 in the first space D1, such that the vibration of the grip 130R in the radial direction can be made possible, and the vibration of the grip 130R in the radial direction can be absorbed by the O-ring 142, such that the vibration is not appreciably transmitted to the body 110.

Furthermore, in the steering assembly 100 according to the embodiment, since the O-ring 142 is provided in the first space D1, the outer peripheral surface 132A of the insertion portion 132 of the grip 130R can be maintained in such a state that the inner peripheral surface 123A of the recess 123 of the holder 120R does not contact the inner peripheral surface, such that vibration in the radial direction of the grip 130R can be prevented from being transmitted to the body 110.

Furthermore, as illustrated in FIG. 3, the depth of the recess 123 is slightly deeper than the thickness of the insertion portion 132 in the axial direction of the grip 130R. Thus, the second space D2 is formed between the inner bottom surface 123B of the recess 123 of the holder 120R and the end surface 132B of the insertion portion 132 of the grip 130R, in which the inner bottom surface 123B and end surface 132B face each other. Therefore, the grip 130R is movable in the second space D2 within the recess 123 in a direction approaching the inner bottom surface 123B of the recess 123, such that the grip 130R can vibrate more in the radial direction, the axial direction of the central axis X, and an inclination direction of the grip 130R.

As a result, the steering assembly 100 according to the embodiment can selectively vibrate the grip 130R to a greater extent, such that the vibration transmitted to the operator's right hand can be increased.

However, four annular O-rings 143 are disposed in the second space D2. Each of the four fixing screws 141 penetrates through the corresponding one of the four annular O-rings 143. The O-rings 143 are an example of a “second elastic member” and are formed by using an elastic material (for example, rubber, silicon, etc.).

The steering assembly 100 according to the embodiment includes the four O-rings 143 in the second space D2, such that vibration in the axial direction of the grip 130R is enabled, and vibration in the axial direction of the grip 130R is absorbed by the four O-rings 143, such that the vibration is not appreciably transmitted to the body 110. Although the O-rings 143 are used as the “second elastic member” in the present embodiment, a plurality of elastic bodies may be disposed in the second space D2 instead.

Furthermore, in the steering assembly 100 according to the embodiment, since the second space D2 is formed, even when the grip 130R is connected to the holder 120R by the fixing screws 141, the vibration of the grip 130R can be prevented from being transmitted to the holder 120R and the body 110. Furthermore, in the steering assembly 100 according to the embodiment, since the end surface 132B of the insertion portion 132 of the grip 130R can maintain a state in which the end surface 132B does not contact the inner bottom surface 123B of the recess 123 of the holder 120R by disposing the four O-rings 143 in the second space D2, it is possible to make it difficult for the vibration of the grip 130R in the axial direction of the central axis X, the vibration in the radial direction, the vibration of the grip 130R moving in an inclined manner, and the like to be transmitted to the body 110.

The holding structure of the grip 130L by the holder 120L is the same as the holding structure of the grip 130R by the holder 120R except that it is symmetrical, and therefore, detailed illustration and description thereof are omitted. Accordingly, the steering assembly 100 according to the embodiment can similarly cause the grip 130L to be selectively vibrated to a greater extent, thereby increasing the vibration transmitted to the operator's left hand.

### Installation Example of Steering Assembly 100

FIG. 4 is a diagram illustrating an installation example of the steering assembly 100 according to the embodiment. FIG. 4 illustrates an example in which the steering assembly 100 according to one embodiment is installed on a handlebar mount 11 provided in a steering apparatus 10 for steering the front wheel of a motorcycle.

The handlebar mount 11 includes a horizontal flat plate 11A and a pair of right and left vertical wall-shaped mount portions 11B provided on the upper surface of the plate 11A. Each of the pair of right and left mount portions 11B includes a notch 11C in the upper portion.

In the steering assembly 100, the central portion 110A of the body 110 is fitted into the notches 11C of the pair of right and left mount portions 11B. The central portion 110A of the body 110 is screwed and fixed to the pair of right and left mount portions 11B by the pair of right and left fixing screws 112 penetrating through the pair of right and left through holes 111.

Thus, the steering assembly 100 is fixed to the handlebar mount 11. In this way, the steering assembly 100 according to the embodiment is fixed to the handlebar mount 11 at the central portion 110A of the body 110, such that vibration of the body 110 can be made less likely to occur.

According to the operation apparatus according to an embodiment, the grip can be selectively vibrated to a greater extent.

Although one embodiment of the present invention has been described in detail above, the present invention is not limited to the embodiment, and various modifications or changes can be made within the scope of the present invention described in the appended claims.

In the above embodiment, each of the grips 130 is provided with the insertion portion 132 protruding from the grip 130, and each of the holders 120 is provided with the recess 123 into which the insertion portion 132 is inserted. However, the grip 130 may be provided with a recess, the holder 120 may be provided with an insertion portion protruding from the holder 120, and a “first elastic member” such as an O-ring may be disposed between the inner peripheral surface of the recess of the grip 130 and the outer peripheral surface of the insertion portion of the holder 120.

Although the fixing screws 141 are used as an example of the “fixer” in the above embodiment, other members may be used as the “fixer”.

Furthermore, the “fixer” may not be provided. Specifically, in the above embodiment, a groove is provided in the outer peripheral surface of the insertion portion 132 of the grip 130 to restrict movement of the O-ring 142 in the axial direction of the central axis X by fitting the O-ring 142 into the groove. At the same time, a groove may also be provided in the inner peripheral surface 123A of the recess 123 to restrict movement of the O-ring 142 in the axial direction of the central axis X by fitting the O-ring 142 into the groove, and the grip 130 may be held by the holder 120 by using the O-ring 142.

Furthermore, in addition to the structure of the above embodiment, a through hole may be provided in the grip 130 to penetrate through the central axis X of the grip 130, a support post may be provided integrally with the holder 120 to penetrate through the through hole, and an elastic member may be provided around the outer peripheral surface of the support post to support the grip 130. In this case, the mounting strength of the grip 130 to the holder 120 can be increased.

Furthermore, in the above embodiment, an example of application of the “operation apparatus” to the steering assembly 100 of a motorcycle has been described as an example, but the “operation apparatus” may be applied to other operation apparatuses (for example, a steering assembly of a bicycle, an operation apparatus of a simulator, an operation apparatus of a game machine, a shift lever of an automobile, and the like).

What is claimed is:

1. An operation apparatus comprising:
a body having a rod shape fixed to an apparatus to be operated;
a holder provided at an end of the body;
a grip held by the holder and grasped by an operator's hand; and
a vibration generating apparatus provided inside the grip, wherein
one of the holder or the grip includes a recess,
another of the holder or the grip includes an insertion portion to be inserted into the recess, and
a first elastic member is provided between an inner peripheral surface of the recess and an outer peripheral surface of the insertion portion.

2. The operation apparatus according to claim 1, wherein
the first elastic member has a shape extending along a circumferential direction of the outer peripheral surface of the insertion portion.

3. The operation apparatus according to claim 1, wherein
an inner bottom surface of the recess and an end surface of the insertion portion, which face each other, are fixed to each other by a fixing member with a space interposed between the inner bottom surface of the recess and the end surface of the insertion portion.

4. The operation apparatus according to claim 3, wherein
the fixing member penetrates through the inner bottom surface of the recess, the space, and the end surface of the insertion portion.

5. The operation apparatus according to claim 4, further comprising:
a plurality of fixing members, each of the fixing members being the fixing member.

6. The operation apparatus according to claim 3, further comprising:
a second elastic member provided in the space.

7. The operation apparatus according to claim 6, wherein
the second elastic member is disposed around the fixing member.

8. A steering apparatus comprising:
a steering assembly including the operation apparatus according to claim 1.
